(19) United States
(12) Patent Application Publication
(10) Pub. No.: US 2022/0079324 A1
(43) Pub. Date: Mar. 17, 2022

(54) Shower-Mounted Oral Hygiene System and Method of Use

(71) Applicant: Susan Nolan, Jupiter, FL (US)

(72) Inventor: Susan Nolan, Jupiter, FL (US)

(21) Appl. No.: 17/023,309

(22) Filed: Sep. 16, 2020

(51) Int. Cl. A45D 44/00; A61C 15/04; A61C 15/02; A45D 42/00

(52) U.S. Cl. CPC A45D 44/00; A45D 42/00; A61C 15/02; A61C 15/043

(57) ABSTRACT

A shower-mounted oral hygiene system and method of use provides a shower-mountable caddy that enables facilitated access and disposal of dental floss and floss picks. The caddy hingedly joins a lid that forms a depressed orifice and an outer cutting member for accessing and cutting dental floss. The caddy has multiple segregated compartments that contain a dental floss dispenser, multiple floss picks, and a waste compartment for collecting used dental floss. A protrusion member extends from the inside of the compartments to retain the floss container and floss picks. A membrane extends across the opening of the compartments to prevent the floss container, floss picks, and used floss from falling out. The caddy also has a mounting mechanism, such as a suction cup, to mount to a shower wall, drainage holes to drain excess water, and a mirror to enable viewing of the flossing function while showering.

### FIELD OF THE INVENTION

The present invention relates generally to a Shower-Mounted Oral Hygiene System and Method of Use. More so, the present invention relates to an oral hygiene system that mounts to a shower wall to enable facilitated access and disposal of a dental floss and multiple floss picks, while also providing a mirror for viewing the flossing functions.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, dental floss is a cord of thin filaments used to remove food and dental plaque from between teeth in areas a toothbrush is unable to reach. The use of floss is commonly recommended in order to prevent gingivitis and the build-up of plaque. A dental floss pick is a small plastic tool with a curved end that holds a piece of dental floss.

A dental professional generally agree that regular flossing promotes dental health. Consequently, people often want to floss their teeth away from home. Carrying dental floss is inconvenient when the carrying container is relatively bulky. Known floss dispensers are not easily stored in a wallet or purse. Commercially available dispensers are relatively thick and use space for features such as a hinged lid. Using a lid to protect the floss is desirable, but not when space is at a premium.

Other proposals have involved oral hygiene devices that dispense dental floss and dental picks. The problem with these oral hygiene devices is that they are easy to stow away and forget about. Also, the dental floss is not always easy to pull from the dispenser. Even though the above cited oral hygiene devices meet some of the needs of the market, a shower-mounted oral hygiene system and method of use, which provides a shower caddy mountable to a shower wall to enable facilitated access and disposal of a dental floss and multiple floss picks, while also providing a mirror for viewing the flossing functions, is still desired.

### SUMMARY

Illustrative embodiments of the disclosure are generally directed to a shower-mounted oral hygiene system and method of use. The shower-mounted oral hygiene system provides a shower-mountable caddy that enables facilitated access and disposal of oral hygiene tools, such as dental floss and a floss pick. The caddy is defined by a lid that forms a depressed orifice for accessing the dental floss, and defined by multiple segregated compartments that contain a dental floss dispenser, multiple floss picks, and a receptacle for collecting used dental floss and floss picks. In some embodiments, a retention membrane extends across at least one of the compartments to retain the floss container, floss picks, and used floss therein. Further, the shower-mounted caddy comprises a mounting mechanism to mount to a shower wall, drainage holes to enable passage of excess water from the shower, and a side mirror to enable viewing of the flossing function while showering.

In one aspect, a shower-mounted oral hygiene system, comprises:
a caddy defined by multiple sidewalls having a top edge, the caddy further defined by a floor wall, the caddy further defined by at least one divider wall, the at least one divider wall and the sidewalls forming a floss compartment having a floss opening and a pick compartment having a floss pick opening;
a waste compartment defined by multiple waste sidewalls and a waste opening, the waste sidewalls detachably joined with one of the sidewalls of the caddy, whereby the waste compartment is adjacent to the floss compartment or the pick compartment;
a mounting mechanism joined with one of the sidewalls of the caddy, or one of the waste sidewalls, or both,
the mounting mechanism enabling detachable mounting to a mounting surface;
at least one membrane extending across at least one of the openings, the membrane forming a passageway; and
a lid comprising a panel and a lower edge, the lid being detachably joined with the top edge of the sidewalls, the lid and the top edge of the sidewalls forming a watertight junction when joined,
the panel having a depression, the depression forming a floss orifice, the floss orifice being disposed in alignment with the floss compartment.

In another aspect, the system further comprises a mirror joined with at least one of the sidewalls.

In another aspect, the floor wall forms multiple drainage holes.

In another aspect, the caddy is defined by a submarine shape.

In another aspect, the waste sidewalls detachably join with the sidewalls of the caddy

In another aspect, the mounting mechanism comprises a suction cup.

In another aspect, the system further comprises at least one protrusion member extending from the sidewalls and the at least one divider wall of the compartments.

In another aspect, the waste sidewalls detachably joins with one of the sidewalls of the caddy with a rail and flange coupling mechanism.

In another aspect, the protrusion member includes at least one of the following: a rubber protrusion, a rib, a foam cylinder, and a net.

In another aspect, the system further comprises an outer cutting member positioned at the depression in the panel.

In another aspect, the outer cutting member is disposed at the periphery of the floss orifice.

In another aspect, the inner and outer cutting member include at least one of the following: a plastic sharp edge, a jagged edge, a metal blade, a plastic blade, a razor, and a scissor-like mechanism.

In another aspect, the membrane comprises a silicone membrane.

In another aspect, at least a section of the lower edge of the lid is hingedly joined with the top edge of the sidewalls.

In another aspect, the panel of the lid is transparent.

In another aspect, the panel of the lid is dome-shaped.

In another aspect, the system further comprises a floss container disposed in the floss compartment.

In another aspect, the floss container comprises a section of floss and an inner cutting member.

In another aspect, the section of floss passes through the floss orifice of the lid.

In another aspect, the system further comprises multiple floss picks disposed in the pick compartment.

In another aspect, the floss picks comprising a plastic tool defined by a curved end that holds a piece of dental floss.

One objective of the present invention is to remind a user to floss the teeth while showering by mounting a floss caddy on a shower wall.

Another objective is to facilitate dispensing of dental floss and floss picks.

Yet another objective is to restrict the floss container and the floss picks from falling out of their respective compartments.

An exemplary objective is to provide enable the waste compartment to detach from the caddy for dispensing used dental floss and used floss picks.

Yet another objective is to form a depression around the floss orifice to facilitate gripping the end of the section of floss.

Another objective is to enable a user to view the flossing with a mirror.

Additional objectives are to provide an inexpensive to manufacture shower-mounted oral hygiene system.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary shower-mounted oral hygiene system, in accordance with an embodiment of the present invention;

FIG. 2 illustrates a perspective view of the shower-mounted oral hygiene system, showing the lid with floss orifice, in accordance with an embodiment of the present invention;

FIG. 3 illustrates a bottom view of the shower-mounted oral hygiene system, in accordance with an embodiment of the present invention; and

FIG. 4 illustrates a perspective view of the shower-mounted oral hygiene system being mounted on a shower wall, in accordance with an embodiment of the present invention.

Like reference numerals refer to like parts throughout the various views of the drawings.

### DETAILED DESCRIPTION OF THE INVENTION

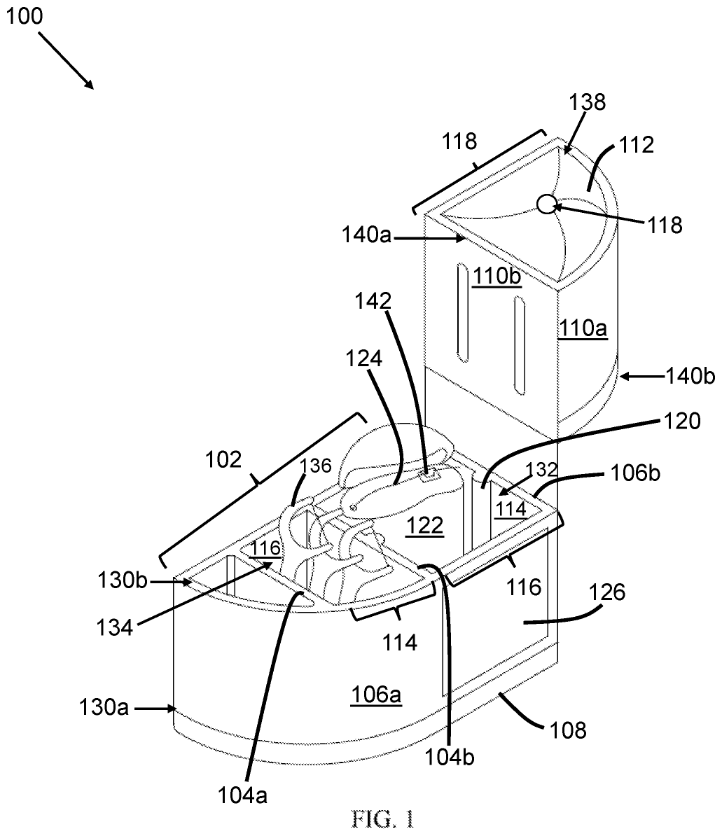

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

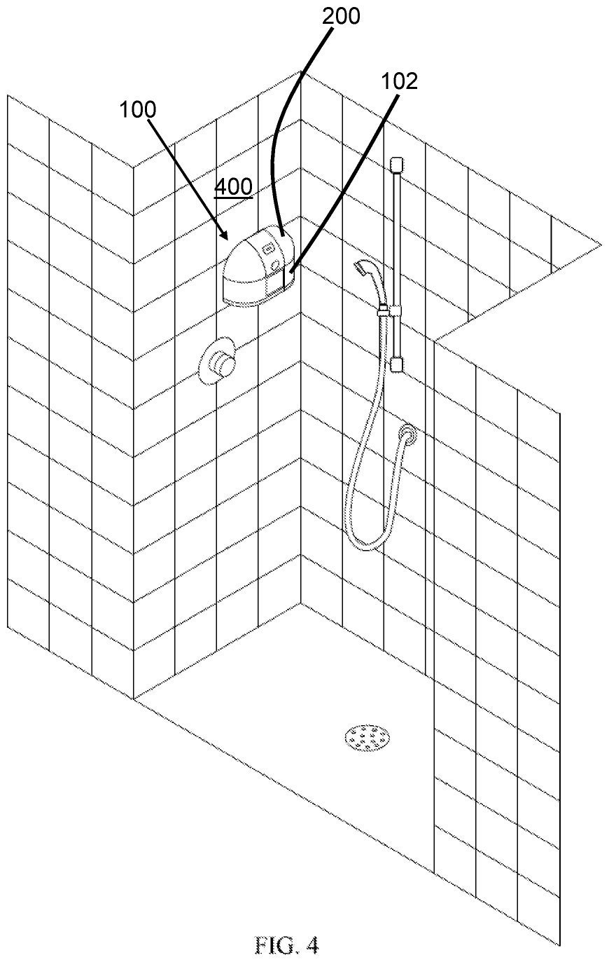

A shower-mounted oral hygiene system 100 and method of use is referenced in FIGS. 1-4. The shower-mounted oral hygiene system 100, hereafter “system 100”, provides a shower-mountable caddy 102 that enables facilitated access and disposal of a section of dental floss 124 and floss picks. The caddy 102 has multiple segregated compartments 114, 116 that contain a dental floss dispenser and multiple floss picks; and a waste compartment 118 for collecting used dental floss and used floss picks 136. A protrusion member 120 extends from the inside of the compartments to retain the floss container 122 and floss picks 136. A membrane 112 extends across the opening of the compartments to prevent the floss container 122, floss picks 136, and used floss from falling out. A lid 200 hingedly, or detachably, joins the top edge of the sidewalls that form the caddy 102. The lid 200 forms a depressed orifice and an outer cutting member for accessing and cutting dental floss. The floss orifice 204 aligns above the floss compartment 114. The caddy 102 also has: a mounting mechanism 300a, 300b, such as a suction cup, to mount to a shower wall, drainage holes 302a, 302n to drain excess water, and a mirror 126 to enable viewing of the flossing function while showering. The unique configuration of the system 100 helps to remind a user to floss the teeth while showering by mounting a floss caddy 102 on a shower wall 400. The system 100 is also effective for facilitating the dispensing and disposal of a section of dental floss 124 and floss picks 136 directly from a shower. For example, FIG. 4 illustrates a perspective view of the shower-mounted oral hygiene system 100 being mounted on a shower wall 400.

As referenced in FIG. 1, the system 100 comprises a caddy 102, which is essentially a container segregated into multiple compartments 114, 116, 118, and often used in bathroom and hygienic settings. In one non-limiting embodiment, the caddy 102 is defined by a submarine shape. However, the caddy 102 may also have other shapes, such as a rectangular shape, a cubical shape, an oval shape, and an irregular shape. Suitable materials for the caddy 102 may include, without limitation, polyurethane, polypropylene, medical grade plastic, stainless steel, and metal alloys.

The caddy 102 is defined by multiple sidewalls 106a-b that forms the external frame. The sidewalls 106a, 106b may extend vertically or along a concave configuration, from a bottom edge 130a to an opposing top edge 130b. The caddy 102 also includes a floor wall 108 that extends across the bottom edge 130a of the sidewalls 106a-b. In one embodiment, four sidewalls form a roughly rectangular shape. However, in other embodiments, any number of sidewalls may be used to form any shape or size of caddy.

Looking now to the interior of the caddy 102, at least one divider wall 104a-b segregates the caddy 102 into multiple compartments 114, 116. In one embodiment, the divider wall 104a, 104b extends at an orthogonal between two opposing sidewalls 106a-b. However, different angles and slopes may be used between the various sidewalls 106a-b and divider walls 104a-b to achieve a desired configuration or ornamental design. In one possible embodiment, the at least one divider wall 104a-b and the sidewalls 106a-b form a floss compartment 114. The floss compartment 114 is configured with a floss opening 132. The divider wall 104a-b and the sidewalls 106a-b also form a pick compartment 116 defining a floss pick opening 134. The openings are sized and dimensioned to enable access to the dental floss and the floss picks 136, respectfully.

In one possible embodiment, a floss container 122 positions inside the floss compartment 114. The floss container 122 is configured to dispense a section of floss 124, such that the floss dispenses directly form the floss compartment 114. In one embodiment, the floss container 122 comprises a section of floss 124 and an inner cutting member 142. A spool may carry the section of floss 124 while being drawn out of the floss container 122. The system 100 may also include multiple floss picks 136 that are vertically positioned in the pick compartment 116. The floss picks 136 can be pulled directly from the pick compartment 116. The floss picks 136 may be of the type that include a plastic tool defined by a curved end that holds a piece of dental floss.

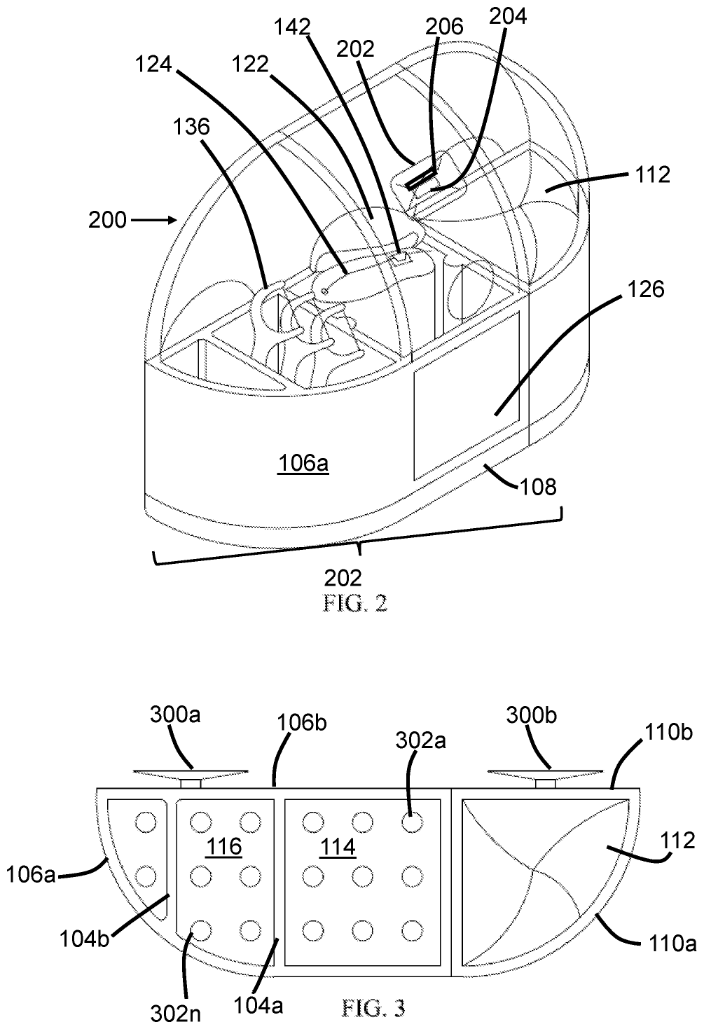

Turning now to FIG. 2, the system 100 further comprises at least one protrusion member 120, used to help retain the floss container 122 and the floss picks 136 in their respective compartment 114, 116. The at least one protrusion member 120 extends from the inner surfaces of the caddy sidewalls 106a-b and/or the divider wall 104a-b. In some embodiments, the protrusion member 120 may include, without limitation, a rubber protrusion, a rib, a foam cylinder, and a net. The protrusion member 120 is simply a retention-styled mechanism that works to create less space, and greater friction inside the compartments. The protrusion member 120 serves to restrict movement (falling out) by the floss container 122 and the floss picks 136. This achieves an objective of restricting the floss container 122 and the floss picks from falling out of their respective compartments. In alternative embodiments, more than two compartments may be used for other oral hygiene related items, or shower related items.

Used in conjunction with, and in some embodiments, integral with the compartments of the caddy 102, is a waste compartment 118. As shown in FIG. 1, the waste compartment 118 is similarly sized and dimensions as the floss compartment 114 and the pick compartment 116. However, in other embodiments, each compartment may be shaped and sized similarly and differently, in any combination. The waste compartment 118 is defined by multiple waste sidewalls 110a-b that extend from a bottom edge 140a to a top edge 140b, approximately at the same dimensions as the floss compartment 114 and the pick compartment 116.

Further, the waste compartment 118 is defined by a waste opening 138 at the top edge 140b. The waste opening 138 is sized to enable access to the interior of the waste compartment 118. Because of the waste opening 138, the waste compartment 118 is configured to contain used dental floss pieces, used floss picks, and other waste commonly found in a shower. Thus, by enabling the waste sidewalls 110a-b to detach from the caddy 102, the contents of the waste compartment 118 may be discarded easily.

In one possible embodiment, the waste sidewalls 110a-b detachably join with one of the sidewalls 106a, 106b of the caddy 102. In this manner, the waste compartment 118 is adjacent to the floss compartment 114 or the pick compartment 116. Thus, in one embodiment, the waste compartment 118 may be fixedly joined to the sidewalls of the caddy 102. And in other embodiments, the waste compartment 118 detaches and attaches to the floss compartment 114 or the pick compartment 116. In an alternative embodiment, the waste compartment 118 is integral with the other compartments 114, 116, such that the caddy 102 includes all three compartments 114, 116, 118.

In one possible embodiment, the waste sidewalls 110a, 110b detachably join with one of the sidewalls 106a-b of the caddy 102 through use of a rail and flange coupling mechanism. In this configuration, a rail and a flange on opposing sidewalls slidably engage to couple and decouple the caddy 102 from the waste compartment 118. However, other fastening means between compartments may also be used, including, but without limitation, magnets, adhesives, bolts, hooks, thread bolts, and hook and loop fasteners.

Looking again at FIG. 2, the system 100 provides at least one membrane 112 that extends across at least one of the openings, sealing at the edges to the perimeter of the divider wall 104a-b and sidewalls 106a-b, 110a-b. Thus, the membrane 112 can extend across the floss opening 132 in the floss compartment 114, the floss pick opening 134 in the pick compartment 116, and the waste opening in the waste compartment 118. The membrane 112 may also form a passageway, or a slit with a flap, for example, to enable access to the interior of the compartments. In one non-limiting embodiment, the membrane 112 comprises a silicone membrane 112. This achieves an objective of restricting the floss container 122 and the floss picks from falling out of their respective compartments.

As shown in FIG. 1, the system 100 further comprises a mirror 126 that mounts to the outer surface of at least one of the sidewalls 106a-b of the caddy 102, or one of the waste sidewalls 110a-b. The mirror 126 is positioned on the outer surface of the sidewalls, so as to enable the user to view the teeth/mouth while flossing or picking at the teeth. In some possible embodiments, the mirror 126 may have a rectangular, circular, or square shape.

In other embodiments, the system 100 provides a mounting mechanism 300a, 300b that joins with the outer surface of one of the sidewalls 106a-b of the caddy 102, or one of the waste sidewalls 110a-b. The mounting mechanism 300a-b may join with a sidewall opposing the mirror-mounted sidewall. The mounting mechanism 300a-b enables the caddy 102 and waste compartment 118 to be mounted to a wall, such as a shower wall 400 (See FIG. 4). In one non-limiting embodiment, the mounting mechanism is a suction cup, or two spaced-apart suction cups (See FIG. 3) However, in alternative embodiments, the mounting mechanism may include, without limitation, an adhesive, a bolt, a magnet, and a hook and loop fastener.

Serving as a cover for the caddy 102 and the waste compartment 118, the system 100 provides a lid 200. The lid 200 comprises a panel and a lower edge, with the lower edge circumambulating the lower sections of the panel. In one non-limiting embodiment, the panel of the lid 200 is transparent and dome-shaped. However, the lid 200 may also be flat, concave, or convex in other embodiments.

In some embodiments, the lid 200 detachably joins with the top edge of the sidewalls 106a-b, 110a-b. This may include a hinged relationship where the lid 200 pivots up to an open position, and pivots down to a closed position. However, in other embodiments, the lid 200 may slidably cover the caddy 102 and waste receptacle, or the lid 200 may completely detach in a snap-fit relationship, for example. Further, the lid 200 and the top edge of the sidewalls 106a-b forming a watertight junction when joined in the closed position. This can be useful since the system 100 is operable in a shower, where water is continuously being sprayed.

In some embodiments, the panel of the lid 200 has a depression. The depression 202 may be a small, centrally located depression that creates a concave void on the surface of the panel. The depression 202 forms a floss orifice 204. The floss orifice 204 is disposed in alignment with the floss compartment 114. The floss orifice 204 allows a section of floss 124 to be pulled therethrough while the lid 200 is in the closed position.

In one embodiment, the system 100 further comprises an outer cutting member positioned at the depression in the panel. The outer cutting member 206 is disposed at the periphery of the floss orifice, which allows for easy cutting of dental floss after a desired length has been pulled out. In some embodiments, the inner and outer cutting members 142, 206 may include, without limitation, a plastic sharp edge, a jagged edge, a metal blade, a plastic blade, a razor, and a scissor-like mechanism. In one exemplary embodiment, the outer cutting member 206 is a small blade at the edge of the floss orifice. The blade is sufficiently sharp to cut a desired length of the section of floss.

The depression in the lid 200, having the concentric floss orifice, allows the fingers more space for gripping the end of section of floss. In some embodiments, the section of floss passes through the floss orifice of the lid 200 as the user pulls the end of the floss out of the floss compartment 114. The user may then cut a desired length of floss with the inner cutting member 142 if the lid 200 is in the open position; or cut the floss with the outer cutting member 206 if the lid 200 is closed position.

In operation, a caddy is prepared for loading with dental floss container and multiple floss picks 128. The user initially removes the lid to the open position to access a floss compartment and a pick compartment. A dental floss container 122 and multiple floss picks 128 are positioned inside their respective compartment. At least one protrusion member extends from the sidewalls of the compartments to retain the floss container and floss picks inside their respective compartment. The waste compartment is attached to the caddy, if not already attached. The Lid is moved to the closed position. A section of dental floss is pulled through the floss orifice in the lid, and cut with the outer cutting member 206 positioned at the depression in the panel. The section of floss may then be used to floss the teeth, as desired.

Continuing with the method of use, the floor wall of the caddy is oriented towards, and attached to the shower wall through use of the mounting mechanism, which may simply be suction cups. When needed, the lid is moved to the open position and a section of floss, or a floss pick is retrieved from the compartment. The floss may be cut to a desired length with an inner cutting member. However, as described above, the dental floss may also be accessed while the lid is closed, through the floss orifice in the lid. With the lid in the open position, the used section of floss or floss pick is discarded into the waste compartment. A flexible silicone membrane 112 may have to be urged into the waste compartment to enable passage through a passageway in the membrane 112. The waste compartment may be detached and the contents discarded, so as to empty the waste compartment.

In conclusion, a shower-mounted oral hygiene system and method of use provides a shower-mountable caddy that enables facilitated access and disposal of dental floss and floss picks. The caddy hingedly joins a lid that forms a depressed orifice and an outer cutting member for accessing and cutting dental floss. The caddy has multiple segregated compartments that contain a dental floss dispenser, multiple floss picks, and a waste compartment for collecting used dental floss. A protrusion member extends from the inside of the compartments to retain the floss container and floss picks. A membrane extends across the opening of the compartments to prevent the floss container, floss picks, and used floss from falling out. The caddy also has a mounting mechanism, such as a suction cup, to mount to a shower wall, drainage holes to drain excess water, and a mirror to enable viewing of the flossing function while showering.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A shower-mounted oral hygiene system, the system comprising:
a caddy defined by multiple sidewalls having a top edge, the caddy further defined by a floor wall forming multiple drainage holes, the caddy further defined by at least one divider wall, the at least one divider wall and the sidewalls forming a floss compartment having a floss opening and a pick compartment having a floss pick opening;
a waste compartment defined by multiple waste sidewalls and a waste opening, the waste sidewalls detachably joined with one of the sidewalls of the caddy, whereby the waste compartment is adjacent to the floss compartment or the pick compartment;
a mounting mechanism joined with one of the sidewalls of the caddy, or one of the waste sidewalls, or both,
the mounting mechanism enabling detachable mounting to a mounting surface;
at least one membrane extending across at least one of the openings, the membrane forming a passageway; and
a lid comprising a panel and a lower edge, the lid being detachably joined with the top edge of the sidewalls, the lid and the top edge of the sidewalls forming a watertight junction when joined,
the panel having a depression, the depression forming a floss orifice, the floss orifice being disposed in alignment with the floss compartment.

2. The system of claim 1, further comprising a mirror joined with at least one of the sidewalls.

3. The system of claim 1, wherein the mounting mechanism comprises a suction cup.

4. The system of claim 1, further comprising at least one protrusion member extending from the sidewalls and the at least one divider wall of the compartments.

5. The system of claim 4, wherein the protrusion member includes at least one of the following: a rubber protrusion, a rib, a foam cylinder, and a net.

6. The system of claim 1, wherein the waste sidewalls detachably join with one of the sidewalls of the caddy with a rail and flange coupling mechanism.

7. The system of claim 1, further comprising an outer cutting member positioned at the depression in the panel.

8. The system of claim 7, wherein the outer cutting member is disposed at the periphery of the floss orifice.

9. The system of claim 1, wherein the membrane comprises a silicone membrane that extends across the waste opening.

10. The system of claim 1, wherein at least a section of the lower edge of the lid is hingedly joined with the top edge of at least one of the sidewalls.

11. The system of claim 1, wherein the panel of the lid is transparent and dome-shaped.

12. The system of claim 1, further comprising a floss container disposed in the floss compartment.

13. The system of claim 12, wherein the floss container comprises a section of floss and an inner cutting member.

14. The system of claim 13, wherein the section of floss passes through the floss orifice of the lid.

15. The system of claim 13, wherein the inner and outer cutting member include at least one of the following: a plastic sharp edge, a jagged edge, a metal blade, a plastic blade, a razor, and a scissor-like mechanism.

16. The system of claim 1, further comprising multiple floss picks disposed in the pick compartment.

17. A shower-mounted oral hygiene system, the system comprising:
a caddy defined by multiple sidewalls having a top edge, the caddy further defined by a floor wall forming multiple drainage holes, the caddy further defined by at least one divider wall, the at least one divider wall and the sidewalls forming a floss compartment having a floss opening and a pick compartment having a floss pick opening;
at least one protrusion member extending from the sidewalls and the at least one divider wall of the compartments;
a waste compartment defined by multiple waste sidewalls and a waste opening, the waste sidewalls detachably joined with one of the sidewalls of the caddy, whereby the waste compartment is adjacent to the floss compartment or the pick compartment;
a mirror joined with at least one of the sidewalls;
a mounting mechanism joined with one of the sidewalls of the caddy, or one of the waste sidewalls, or both,
the mounting mechanism enabling detachable mounting to a mounting surface;
at least one membrane extending across at least one of the openings, the membrane forming a passageway;
a lid comprising a panel and a lower edge, at least a section of the lower edge of the lid being hingedly joined with the top edge of the sidewalls, the lower edge of the lid and the top edge of the sidewalls forming a watertight junction when joined,
the panel having a depression, the depression forming a floss orifice, the floss orifice being disposed in alignment with the floss compartment; and
an outer cutting member positioned at the depression in the panel.

18. The system of claim 17, further comprising a floss container disposed in the floss compartment, and multiple floss picks disposed in the pick compartment.

19. The system of claim 18, wherein the floss container comprises a section of floss and an inner cutting member, the section of floss passing through the floss orifice of the lid.

20. A shower-mounted oral hygiene system, the system consisting of:
a caddy defined by multiple sidewalls having a top edge, the caddy further defined by a floor wall forming multiple drainage holes, the caddy further defined by at least one divider wall, the at least one divider wall and the sidewalls forming a floss compartment having a floss opening and a pick compartment having a floss pick opening;
at least one protrusion member extending from the sidewalls and the at least one divider wall of the compartments;
a waste compartment defined by multiple waste sidewalls and a waste opening, the waste sidewalls detachably joined with one of the sidewalls of the caddy, whereby the waste compartment is adjacent to the floss compartment or the pick compartment;
a mirror joined with at least one of the sidewalls;
a mounting mechanism joined with one of the sidewalls of the caddy, or one of the waste sidewalls, or both,
the mounting mechanism enabling detachable mounting to a mounting surface;
at least one silicone membrane extending across the waste opening, the membrane forming a passageway;
a transparent lid comprising a dome-shaped panel and a lower edge, at least a section of the lower edge of the lid being hingedly joined with the top edge of the sidewalls, the lid and the top edge of the sidewalls forming a watertight junction when joined,
the panel having a depression, the depression forming a floss orifice, the floss orifice being disposed in alignment with the floss compartment; and
an outer cutting member positioned at the depression in the panel.
